(19) United States
(12) Patent Application Publication
(10) Pub. No.: US 2013/0214451 A1
(43) Pub. Date: Aug. 22, 2013

(54) Widening Device

(71) Applicant: Florian Fischer, Ebersberg (DE)

(72) Inventor: Florian Fischer, Ebersberg (DE)

(21) Appl. No.: 13/806,053

(22) PCT Filed: Jun. 3, 2011
(86) PCT No.: PCT/EP11/59218

§ 371 Date: Mar. 5, 2013

(30) Foreign Application Priority Data
Jun. 8, 2010 (DE) 10 2010 017 290.1

(51) Int. Cl. B29D 30/52

(52) U.S. Cl. CPC B29D 30/52
USPC 264/291; 425/383

(57) ABSTRACT

The invention relates to a covering device, comprising a feeding device for a tread strip, by means of which the tread strip can be fed to a carcass, wherein a connecting device is provided which allows ends (21, 22) of the tread strip (14) to be connected to one another, and wherein a widening device (16) widens the tread strip (14) that is connected at the ends and is in the form of a ring until an inside diameter of the tread strip (14) is reached which corresponds to, or is greater than, the outside diameter of the carcass (48).

### TECHNICAL FIELD

This invention concerns a covering device for covering a tire carcass with a strip-type tread strip which device includes a widening device for a tread strip, by means of which the tread strip can be fed to a carcass, as well as a method for remolding and/or producing a vehicle tire from a carcass and a tread strip, which tread strip is widened and applied to the periphery of the carcass.

### BACKGROUND OF THE INVENTION

For covering carcasses for the remolding of tires, a tread strip is produced in most cases, for example by means of extrusion, and is provided in the shape of strips. The tread strip is then brought in contact with the carcass and is stretched a little during the process of application, such that it is in close contact with the carcass.

Uniform stretching requires a significant effort in the fields of control technology and measuring technology, for both ends of the tread strip must fit together when they are applied to the carcass, in order to prevent any rubber beads from causing an imbalance in the tire.

This effort is almost beyond control in case of different diameters of carcasses, as cannot be ruled out in practice.

When the old tires, whose carcasses are to be prepared for remolding, are excoriated, such scraper knives are typically employed which remove the used-up tread of the old tire. Depending on the age of the old tire, the rubber mixture used, partly also depending on the pattern of the old tire, and in particular subject to whether a summer or a winter tire was used, the scraper knives now enter the old tire in different ways. In case of a more flexible old tire, there is heavier deflection, whereas a less flexible old tire is typically gripped deeper by the scraper knife. Even if excoriation can be effected with the help of machines and automatically, the result will still include different diameters of carcasses, for example typically differing by a few millimeters.

One example for a length-measuring device for optimizing the length of the tread strip can be taken from DE 28 29 660 A1. In this solution, an overlapping of the ends of the tread band is intended which is supposed to make the precision of the tread strip stretch less critical.

It has also been suggested to distinctly reduce the cutting angle of the tread strip ends in order to allow insofar a larger tolerance. Although this is possible in principle, in case of deviations from the correct length of the tread strip, which is supposed to fit to the respective excoriated carcass, either a bead or an indentation in the tread strip applied will be caused.

Furthermore, it is known from DE 695 14 062 T2 to perform the lengthening during the application of the tread strip to the carcass under visual monitoring.

Although this method is basically possible, it requires extremely much manpower and is very much dependent on the qualification and experience of the operator.

Furthermore, a basically different type of producing tread bands has become known, with the help of which uniform stretching is possible without any problem:

In this method, the tread band is produced in a ring shape in the first place with the help of a special mould, and is provided to the carcass via a widening device. This method is extremely elaborate as far as production of the ring-shaped tread band cord is concerned, for it is basically necessary to manufacture different moulds for each size of tire, which needs to be done specifically for the production of the tread band and as far as both the width and the diameter are concerned.

With the multitude of tires used these days, for example for the production of the tread band alone—i.e. independently of vulcanization—for example, 50 special moulds would be required once, such that it is not amazing that this method was mainly used in the past. Examples for such solutions can be taken from DE 1 089 957 and DE 1127 070, with the widening being supposed to be realized with the help of air pressure in each case.

A somewhat more modern method, which, however, has not been able to gain acceptance either, can be taken from DE 27 18 080 A1.

U.S. 2002/0170652 A1 concerns a method for applying an annular tread to a pneumatic tire casing which has the steps of mounting the tread on a tread expander assembly wherein the tread pass over a mount wheel prior to the casing being mounted onto the mount wheel. In accordance with the apparatus, the mechanism for supporting the casing and the tread extended from one end allows the operator to work in front of the apparatus.

U.S. 2005/0034804 A1 discloses a re-treading apparatus and a method, for winding a tread material on a base tire to realize an adequate joint condition of the respective edges of the tread material. Here a photograph of a zone of the tread material including its cut position is taken to compare the photograph with a stored tread pattern image to thus detect a deviation amount between them. In case of a deviation, the misalignment is corrected by cutting the tread material and uniting the trailing edges of the tread material again on the casing.

JP 6 047838 A concerns a method for manufacturing a pneumatic tire wherein peeling-off from adhered end parts of an expanded tread rubber is prevented from occurring. When an unvulcanized tread rubber in which an expanding agent is mixed is to be wound on a green case, end parts of the tread rubber are heated by halogen lamps, as the heated parts have stickiness. The green tire vulcanized under a predetermined condition has thus no cells at the respective end parts and is adhered assuredly, so that peeling-off does not occur when the tire is being used.

JP 59 143611 A discloses a process for molding continuously a thermal contraction tube whose contraction rate, thickness and length are freely selectable, wherein a flat tape is discharged from a flat die, is supplied to a pivot body, and the flat tape is wound around the pivot body and is overlapping in the process.

WO 2007/061400 A1 concerns a method and an apparatus for forming a core of plies and belts for positioning the core in a mold for forming an elastomeric tire. The core is built up on a mandrel of an inner mold that is formed from hard foam core segments positioned between top, bottom and a centre hub plates. Plies for building the core are formed as a woven sleeve for passage along an expander cone.

So, the methods used are either too expensive (old method with ring-shaped tread strips) or have quality problems (new method with tread bands), unless a considerable effort is made as far as measuring and control technology is concerned.

### OBJECTS AND SUMMARY OF THE INVENTION

For this reason, the invention has the purpose of creating a covering device for covering a carcass with a strip-type tread strip which device includes a feeding device for a tread strip, by means of which the tread strip can be fed to a carcass, as well as a method remolding and/or producing a vehicle tire from a carcass and a tread strip, which tread strip is provided in a pre-determined length which suits the periphery of the carcass, and which make possible the production of high-quality remolded tires despite a comparatively low effort.

In accordance with the present invention, it is intended that a tread strip is produced in a basically known fashion in the form of strips. The ends of the tread strip are then attached to one another with the help of a connecting device, such that a ring-shaped tread strip results.

This surprisingly simple measure makes it possible to combine the advantages of the production of strip-shaped tread strips with the advantages of the production of ring-shaped tread strips.

For in accordance with the present invention a widening device can be employed which allows a uniform widening of the tread strip over its entire circumference. Problems concerning the splice of the ends of the tread strip will not result because the connecting device will always hold the ends together in the desired fashion, also during the process of widening.

Since widening is typically connected with a reduction in strength of the tread strip, it is favorable if, as a result of the pressure exerted to the ends of the tread strip by means of the connecting device, their strength is also reduced there.

In this fashion, it is possible to produce a ring-shaped tread strip without any impairment to quality at the splice, i.e. without any bead or indentation, which holds true also if the carcass dispersion is large, i.e. if the carcasses are simply just excoriated without any re-peeling being effected.

The method in accordance with the present invention makes it possible to work at a rather high number of cycles, for instance if widening is effected in one go subsequently to cutting the tread strip to length and transferring the tread strip into its ring shape.

For this purpose, an automatic widening device can be employed which is put into practice either by means of over-pressure applied to the tread strip from the inside, under-pressure applied to the tread strip from the outside or a mechanics, with which it is particularly favorable if the widening device is connected to a conveyor device which transfers the tread strip to the carcass right away.

Alternatively the ring-/strip-shaped tread strip can then be widened with the help of a spreading device which is so effective that after the process of widening, it will correspond in its diameter in any case to the largest outside diameter of a carcass which might be present. The ring-shaped tread strip which has been widened with the help of the spreading device is then pushed onto the carcass laterally, while the connecting device holds the ends of the tread band.

When the spreading device is used, the tread strip will remain on the carcass in the spread, ring-shaped condition, even when the connecting device is loosened.

Alternatively, it is also possible to effect an elastic deformation of the tread strip, which has the advantage that the tread strip will then be in better contact with the carcass. In this embodiment, the connecting device is loosened only when the adhesion between the surface of the tread strip and the carcass is sufficient for preventing the tread strip from any elastic contraction.

### BRIEF DESCRIPTION OF THE FIGURES

Further advantages, details and features result from the following description of a number of exemplary embodiments of the invention with the help of the drawings which show in:

FIG. 1 a schematic depiction of a feeding device for a tread strip as a part of a covering device in accordance with the present invention;

FIG. 2 an embodiment of a widening device as a part of a covering device in accordance with the present invention;

FIG. 3 a modified widening device compared with the widening device in accordance with FIG. 2;

FIG. 4 a connecting device as a part of a covering device in accordance with the present invention;

FIG. 5 another embodiment of a widening device in accordance with the present invention; and

FIG. 6 another embodiment of a widening device in accordance with the present invention.

### DETAILED DESCRIPTION

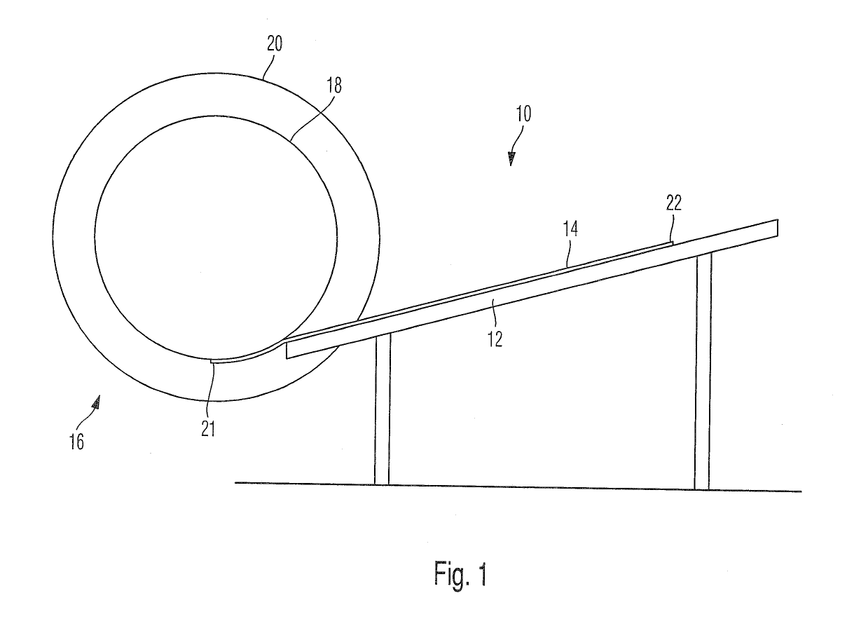

The covering device 10 depicted schematically in FIG. 1 includes an inclined table 12 which is formed in a basically known fashion in order to cut to length a tread strip 14 and transport it to a carcass. For this purpose, the inclined table 12 comprises a cutting device and a measuring device which are not depicted.

It can furthermore be taken from FIG. 1 that the inclined table 12 has an inclination which makes it possible for the tread strip 14 to slide downwards towards the carcass. Such it is also made sure that the operator does not need. to lift the carcass too high, but can still cut off the tread strip 14 at the desired place standing upright.

In accordance with the present invention, it is particularly favorable that a widening device 16 is positioned immediately adjoining the inclined table.

The widening device 16 comprises a drum 18 with a smaller diameter and a drum 20 with a larger diameter, with the difference in diameter being depicted in FIG. 1 and the further Figures in a distinctly excessive fashion for the purpose of clarification.

As can be taken from FIG. 1, the tread strip 14 is supplied to the widening device 16 at the lower peak of the smaller drum 18.

In the embodiment depicted, it is intended to cut the tread strip 14 to a length which essentially corresponds to the outer diameter of the smaller drum 18. By means of rotating the drum 18, the tread strip 14 is positioned around the drum. Then the drum 18 is again rotated by one half-turn, such that the splice of the two ends 21 and 22 of the tread strip 14 reaches about the position at the upper peak of the drum 18. In this position, a connecting device, which is not depicted, is then applied, which moves the ends 21 and 22 to one another edge to edge.

After the clamping has been effected via the connecting device, the originally strip-shaped tread strip 14 is then present in ring shape and can be widened uniformly in its diameter with the help of the widening device 16, such that it fits on the larger drum 20.

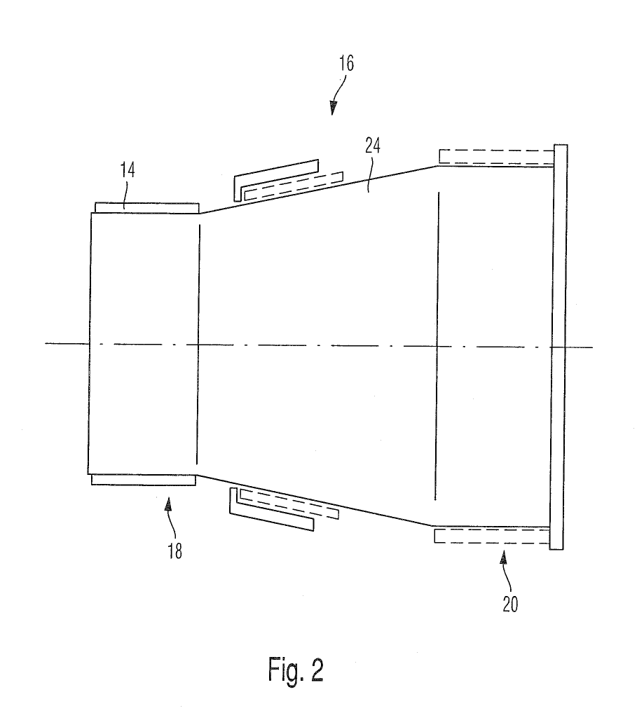

From FIG. 2 an embodiment of the widening device 16 can be taken in a schematic fashion. The tread band 14 is slowly transferred from the drum 18 to the drum 20 via a conical section 24. The embodiment of the widening device depicted here is possible only if the tread band 14 is present in right shape.

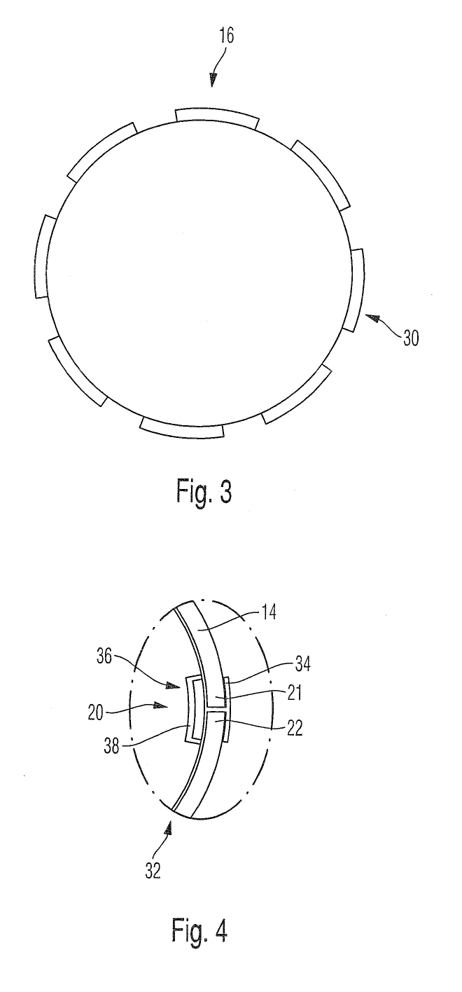

From FIG. 3, a spreading device can be taken in a schematic fashion, which makes it possible to radially widen, i.e. expand, the tread band by means of radial widening of spreading elements 30. With the help of the spreading device, the tread band is expanded to such a degree that it fits over the carcass, which is not depicted. The spreading elements 30 are then lowered in a skewed direction such that the tread strip slides onto the carcass, with “lower’ meaning a radial inward movement of the ends of the spreading elements 30.

A schematically depicted connecting device 32 comprises clamping elements 34 and 36 which are used to clamp the ends 21, 22 of the tread strip 14 to one another edge to edge. In the embodiment depicted, the connecting device is guided in a guide 38 and is moved together with the tread strip 14 during the activation inside the spreading device 16.

It is to be understood that any other types of connecting devices are also possible without leaving the scope of the invention, and it is not ruled out to provide inclined cuts fitting to one another rather than a straight cut at the edges of the ends 21 and 22.

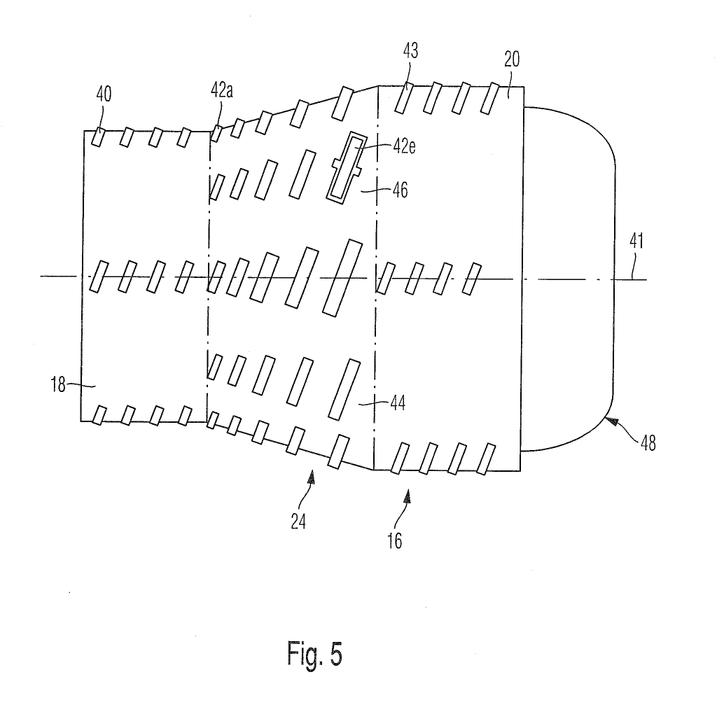

From FIG. 5 another modified embodiment of a widening device 16 can be taken. The widening device 16 has a multitude of rolls 40 which are provided in an inclined position, respectively, both in the area of the drum 18 and in the area of the drum 20, as well as in the conical section 24.

The embodiment of the widening device 16 depicted in FIG. 5 is applicable whenever the tread band is present in an elastic and possibly also slightly sticky condition. In the exemplary embodiment depicted, the drum 18 has a multitude of rolls 40 which exhibit an angle of inclination towards the axis 41 of the widening device 16 of, for example, 20 degrees. The rolls 40. are positioned both behind each other, seen in an axial direction, and in a number of rows around the circumference, such that, for instance, at the same axial position 8 rolls carry the tread strip, which is present there in a ring shape, from the inside and guide it.

Whereas the rolls 40 are preferably provided as mere running rolls, i.e. not driven, the rolls 42 are preferably provided in a particular fashion. The rolls 42 extend within the conical section 24 of the widening device 16 and are smaller in the direction towards the drum 18 and larger in the direction towards the drum 20. They are in contact in an inclined direction with a driving drum 44 from the inside, which driving drum is mounted in a coaxial direction towards the axis of the axis 41. Driving the rolls 42 results in a support for the operator. When he slightly rotates the tread strip which is present in ring shape and is first in contact with the rolls 40, it is moved into the area of the 8 rolls 42a, such that it is driven and is thus virtually automatically widened.

Resulting from the increasing diameter of the rolls 42 in the direction towards the drum 20, a simple drive via the driving drum 44 can be realized, but alternatively it would also be possible to provide electric motors for each of the rolls 42, which, however, would make it necessary in the exemplary embodiment depicted to provide as many as 40 electric motors.

For mounting the rolls 40, 42 and 43, a sort of mounting grid 46 is provided which comprises cut-outs fitting the rolls and is depicted in the area of a roll 42e in schematic fashion.

The rolls 43 of the larger drum 20 are preferably not driven either, corresponding to the rolls 40.

Adjoining the large drum 20, the tread strip is supplied to the carcass 48 by means of continued rotation, until it is firmly fitted on the circumference of the carcass 48.

It is particularly favorable if the carcass outer diameter of the carcass 48 is a little smaller than the diameter of the larger drum 20. Then the carcass 48 can be introduced into the drum 20 at least partially, such that it is possible without any problem to transfer the tread strip 14 to the carcass 48, for which purpose the tread strip is further unrolled from the large drum while at the same time the carcass 48 is moved out of the drum 20.

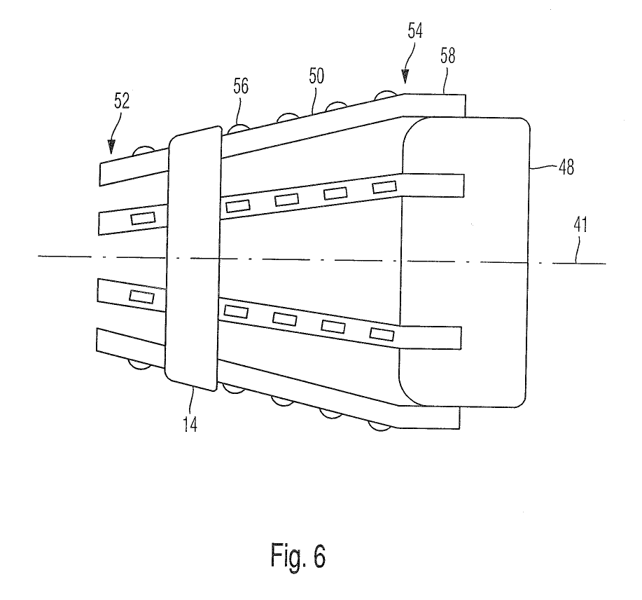

From FIG. 6, a modified embodiment of a widening device 16 can be taken. The widening device 16 has a multitude of widening fingers 50 which are positioned in a rotationally symmetric and radial fashion around the axis 41, and whose distance to one another continuously increases from the start position 52 to the end position 54. The ring-shaped tread strip 14 reaches the widening fingers 50 at the start position 52 and is transported in the direction towards the end position 54. Due to the thus increasing distance of the widening fingers 50 from one another, the tread strip 14 is increasingly lengthened until it has reached its maximum widening.

Another modification of the widening device in which rolls 56, which are preferably positioned within the fingers 50, facilitate the transport of the tread strip 14 from the position 52 to the end position 54 by reducing friction, can also be taken from FIG. 6. These rolls are necessary from a certain angle which depends on different parameters of the material, such as the rubber mixture of the tread strip, the surface quality of the widening fingers 50, etc, because with an increasing angle of the widening fingers 50 towards the axis 41, the static friction of the tread strip on the widening fingers is considerably increased.

In another preferred embodiment, the widening device 16 in accordance with the present invention can be adapted to different diameters of the carcass by means of a joint variation, which is not depicted, of the angle of the widening fingers 50 towards the axis 41. Here, the variation of the angle can be effected, for instance, with the help of hydraulic, screw or other suitable drives which withstand the high forces occurring during the widening of the tread strips.

Another modification of the widening device, in which the end of the inclined section of the widening fingers 50 is adjoined by a section 58 which extends in a direction parallel to the axis 41, can also be taken from FIG. 6. This axially parallel section 58 preferably has a width which almost corresponds to the width of the tread strip 14 to be widened. Due to this axially parallel end section, the tread strip is one the one hand only transported further towards the carcass 48 to be reconditioned without any further widening. On the other hand, the maximum diameter to which the ring-shaped tread strip needs to be widened is reduced to a minimum due to the axially parallel section, and the introduction of the carcass 48 to be reconditioned into the widening device is facilitated if the widening fingers are supposed to grip over the carcass 48.

It is to be understood that instead of the types of widening devices described here, any other widening devices are possible. For example, a widening device can be realized which makes possible a mechanical widening and contracting over the carcass for the strip-/ring-shaped tread strip of a larger diameter, such that carcasses of distinctly different diameters can also be served.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. Covering device, comprising a feeding device for a tread strip, by means of which the tread strip can be fed to a carcass, characterized in that a connecting device is provided which allows ends (21, 22) of the tread strip (14) to be connected to one another, and that a widening device (16) widens the tread strip (14) that is connected at the ends and is in the form of a ring until an inside diameter of the tread strip (14) is reached which corresponds to, or is greater than, the outside diameter of the carcass (48).

2. Covering device according to claim 1, characterized in that the widening device (16) is suitable for uniformly widening the tread strip (14), except for the ends (21, 22) of the tread strip (14) connected by the connecting device.

3. Covering device according to claim 1, characterized in that the widening device (16) widens the tread strip (14) by less than 10 percent of its diameter and that the tread strip (14) is in contact with the device and puts pressure to it radially inward.

4. Covering device according to claim 1, characterized in that the widening device (16) is provided with a spreading device which widens the ring-shaped tread strip (14) beyond the range of elastic deformation and that the tread strip (14) widened in such a way is suitable for fitting to the carcass surface free of play.

5. Covering device according to claim 1, characterized in that the widening device (16) is provided with different diameters and with a transfer device which transfers the ring-shaped tread strip (14) from a roll with a smaller diameter to a roll of a larger diameter.

6. Covering device according to claim 1, characterized in that the widening device (16) is provided with a plurality of widening fingers (50) which are arranged radially around a central axis (41) and with a transfer device which transfers the ring-shaped tread strip (14) from a position (52) on the widening fingers (50) of a smaller diameter to a position (54) of a larger diameter.

7. Covering device according to claim 6, characterized in that the plurality of widening fingers (50) which are arranged radially around the central axis (41), when the angle between the central axis (41) and the widening fingers (50) exceeds a value of 8°, comprises rolls (56) which facilitate the transport of the ring-shaped tread strip (14) from the position (52) on the widening fingers (50) to the position (54).

8. Covering device according to claim 6, characterized in that the angle of the widening fingers (50), which are arranged radially around the central axis (41), is formed by the widening fingers (50) together with the central axis (41) and is changeable, in particular for all widening fingers (50) together.

9. Covering device according to claim 1, characterized in that the connecting device clamps both ends (21, 22) of the tread strip (14) on both sides.

10. Covering device according to claim 1, characterized in that the connecting device holds both ends (21, 22) of the tread strip (14) in abutment.

11. Covering device according to claim 1, characterized in that the connecting device compresses both ends (21, 22) of the tread strip (14) by at least 30%, preferably by 50%, of their thickness.

12. Covering device according to claim 1, characterized in that the connecting device, during the widening of the ring-shaped tread strip (14), is guided at the widening device (16).

13. Method of remolding and/or producing a vehicle tire from a carcass and a tread strip, which tread strip is provided in a pre-determined length which suits the periphery of the carcass, wherein the tread strip is applied to the periphery of the carcass, characterized in that the tread strip (14) provided in the form of a strip is bent before it is applied and that both its ends (21, 22) are at least attached to each other and that the tread strip ring formed is widened and applied to the carcass (48).

14. Method according to claim 13, characterized in that the tread strip (14) produced in a strip-type manner has a shorter length than the periphery of the carcass (48).
